(19) United States
(12) Patent Application Publication
(10) Pub. No.: US 2015/0299054 A1
(43) Pub. Date: Oct. 22, 2015

(54) SHAPED ARTICLES AND METHOD FOR MAKING THE SAME

(71) Applicant: CORNING INCORPORATED, Corning, NY (US)

(72) Inventors: Steven Bolaji Ogunwumi, Painted Post, NY (US); Huthavahana Kuchibhotla Sarma, Painted Post, NY (US); Elizabeth Margaret Wheeler, Lindley, NY (US)

(21) Appl. No.: 14/646,412

(22) PCT Filed: Dec. 13, 2013
(86) PCT No.: PCT/US13/74883

§ 371 Date: May 21, 2015

Related U.S. Application Data
(60) Provisional application No. 61/746,649, filed on Dec. 28, 2012.

(51) Int. Cl. C04B 38/00; C04B 41/81; B01D 46/00; C04B 35/645; B28B 1/24; B01D 46/24; B28B 3/12; C04B 35/64

(52) U.S. Cl. CPC C04B 38/0006; B28B 3/126; C04B 41/81; C04B 35/64; C04B 35/6455; B28B 1/24; B01D 46/2418; B01D 46/0001

(57) ABSTRACT

A shaped article for use in a separation device may be produced by forming a batch mixture that includes filler material, fibrous material, and an inorganic binder, and shaping the batch mixture into a shaped structure. The fibrous material may have a D₅₀ of greater than or equal to about 4 microns. The batch mixture may include greater than or equal to about 60 parts by weight and less than or equal to about 98 parts by weight of filler material, greater than or equal to about 2 parts by weight and less than or equal to about 40 parts by weight of fibrous material, and greater than or equal to about 10 parts by weight and less than or equal to about 50 parts by weight of inorganic binder per 100 parts by weight of the sum of the filler material and fibrous material, respectively.

This application claims the benefit of priority under 35 U.S.C. §119 of U.S. Provisional Application Ser. No. 61/746,649 filed on Dec. 28, 2012 the content of which is relied upon and incorporated herein by reference in its entirety.

### BACKGROUND

1. Field

The present specification generally relates to shaped articles and, more specifically, to shaped articles for use in separation devices.

2. Technical Background

Various separation applications employ devices for filtering process gas streams. These separation devices may have shaped substrates which are coated with an active material that may be sorbent, catalytic, or reactive to species contained in a process gas stream. For example, some CO₂ capture applications employ honeycomb, pellet, or monolith articles formed from sorbent materials to reduce the concentration of CO₂ in a gas stream. Some of these articles may be produced through a sintering process, usually at temperatures of at least about 1200° C. However, sintering at these temperatures requires an excessive amount of energy and may require specialized equipment. Additionally, the sintered articles must be formed from refractory materials which are often costly.

Accordingly, a need exists for shaped articles for use in separation devices which can be produced at relatively low temperatures.

### SUMMARY

The embodiments described herein relate to shaped articles for use is separation devices. According to one embodiment, a shaped article for use in a separation device may be produced by a method that may comprise forming a batch mixture that may comprise filler material, fibrous material, and an inorganic binder, and shaping the batch mixture into a shaped structure. The fibrous material may have a D₅₀ of greater than or equal to about 4 microns and an average aspect ratio of greater than or equal to about 2:1 and less than or equal to about 20:1. The batch mixture may comprise greater than or equal to about 60 parts by weight and less than or equal to about 98 parts by weight of filler material per 100 parts by weight of the sum of the filler material and fibrous material. The batch mixture may comprise greater than or equal to about 2 parts by weight and less than or equal to about 40 parts by weight of fibrous material per 100 parts by weight of the sum of the filler material and fibrous material. The batch mixture may comprise greater than or equal to about 10 parts by weight and less than or equal to about 50 parts by weight of inorganic binder per 100 parts by weight of the sum of the filler material and fibrous material

In another embodiment, a honeycomb article for use in a separation device may be produced by a method that may comprise forming a batch mixture that may comprise filler material, fibrous material, inorganic binder, and organic binder, shaping the batch mixture into a honeycomb structure. The fibrous material may have a D₅₀ of greater than or equal to about 4 microns and an average aspect ratio of greater than or equal to about 2:1 and less than or equal to about 20:1. The batch mixture may comprise greater than or equal to about 60 parts by weight and less than or equal to about 98 parts by weight of filler material per 100 parts by weight of the sum of the filler material and fibrous material. The batch mixture may comprise greater than or equal to about 2 parts by weight and less than or equal to about 40 parts by weight of fibrous material per 100 parts by weight of the sum of the filler material and fibrous material. The batch mixture may comprise greater than or equal to about 10 parts by weight and less than or equal to about 50 parts by weight of inorganic binder per 100 parts by weight of the sum of the filler material and fibrous material. The batch mixture may comprise greater than or equal to about 1 parts by weight and less than or equal to about 12 parts by weight of organic binder per 100 parts by weight of the sum of the filler material and fibrous material.

In yet another embodiment, a shaped article may comprise the shaped article that may comprise filler material, fibrous material, and inorganic binder, wherein: The shaped article may be for use in a separation device. The fibrous material may have a D₅₀ of greater than or equal to about 4 microns and an average aspect ratio of greater than or equal to about 2:1 and less than or equal to about 20:1. The shaped article may comprise greater than or equal to about 60 parts by weight and less than or equal to about 98 parts by weight of filler material per 100 parts by weight of the sum of the filler material and fibrous material. The shaped article may comprise greater than or equal to about 2 parts by weight and less than or equal to about 40 parts by weight of fibrous material per 100 parts by weight of the sum of the filler material and fibrous material. The shaped article may comprise greater than or equal to about 10 parts by weight and less than or equal to about 50 parts by weight of inorganic binder per 100 parts by weight of the sum of the filler material and fibrous material.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts the structure of a honeycomb article according to one or more embodiments shown and described herein;

FIG. 2 graphically depicts particle size distributions of filler material according to one or more embodiments shown and described herein;

FIG. 3 graphically depicts a particle size distribution of fibrous material according to one or more embodiments shown and described herein;

FIG. 4 graphically depicts the modulus of rupture for samples prepared according to one or more embodiments shown and described herein;

FIG. 5 graphically depicts the specific surface area for samples prepared according to one or more embodiments shown and described herein; and

FIG. 6 graphically depicts the modulus of rupture of samples prepared according to one or more embodiments shown and described herein.

### DETAILED DESCRIPTION

Reference will now be made in detail to various embodiments of shaped articles for use in separation devices, examples of which are illustrated in the accompanying drawings. Whenever possible, the same reference numerals will be used throughout the drawings to refer to the same or like parts. In one embodiment, a shaped article, as described herein, may generally be produced by forming a batch mixture and shaping the batch mixture, such as, for example, through extrusion. The batch mixture may be formed by mixing filler material, fibrous material, and inorganic binder, with a plasticizer such as water. The batch mixture may be extruded, and following extrusion, the shaped article may optionally be heated at non-sintering temperatures, such as at or below about 1000° C. Alternatively, the shaped article may be suitable for use without heating the shaped article. The shaped articles may be used in separation devices for separating one or more chemical species from a fluid stream. For example, the honeycomb article may be used as a substrate and may be coated with an active material that is chemically reactive, catalytic, or sorbent to a species contacted in a process gas stream. Alternatively, the filler material of the honeycomb article may comprise an active material, such that the active material is part of the shaped substrate. Embodiments of shaped articles and method for making shaped articles will be described in more detail herein with specific reference to the appended drawings.

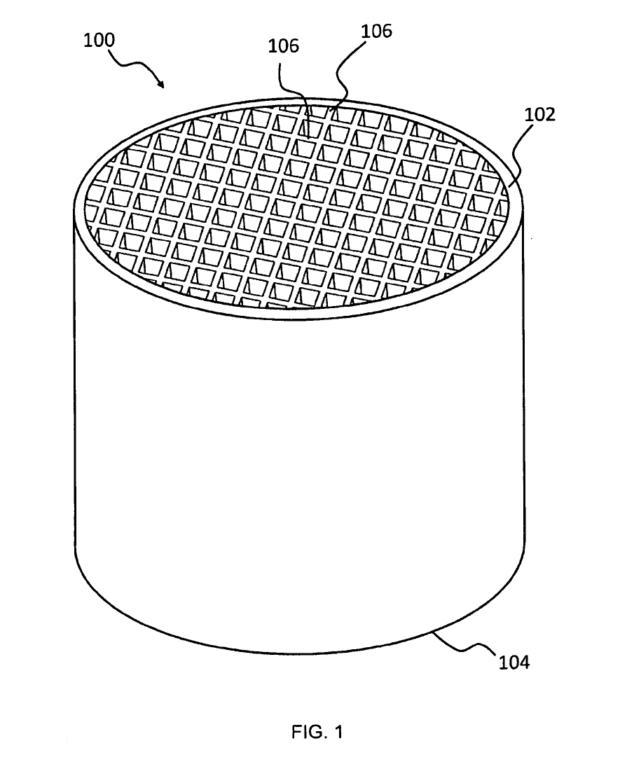

The shaped articles may be shaped into any suitable shape such as, but not limited to, monolithic, honeycomb, spiral wound, sphere, pellet, cylindrical, trilobe, wagonwheel, ring, minilith, foam, plates (flat, curved, corrugated) and/or combinations thereof. In one embodiment, the shaped article may have a honeycomb structure. Referring now to FIG. 1, by way of example, a honeycomb article 100 formed from the compositions described herein is schematically depicted. The honeycomb article 100 generally comprises a honeycomb body having a plurality of cell channels 101 extending between a first end 102 and a second end 104. The honeycomb structure of the article 100 may include the plurality of generally parallel cell channels 101 formed by, and at least partially defined by, intersecting cell walls 106 that extend from the first end 102 to the second end 104. The honeycomb article 100 may also include a skin formed about and surrounding the plurality of cell channels. This skin may be extruded during the formation of the cell walls 106 or formed in later processing as an after-applied skin, such as by applying a skinning cement to the outer peripheral portion of the cells.

In one embodiment, each of the plurality of parallel cell channels 101 are generally square in cross section. However, in alternative embodiments, the plurality of parallel cell channels in the article may have other cross-sectional configurations, including rectangular, round, oblong, triangular, octagonal, hexagonal, and/or combinations thereof.

While FIG. 1 depicts a honeycomb article 100 in which some or all of the channels are plugged, is should be understood that, in alternative embodiments, all the channels of the honeycomb article may be unplugged, such as when the honeycomb article is used as catalytic flow-through substrate.

The shaped article may generally be produced by forming a batch mixture and shaping the batch mixture into a shaped structure. In various embodiments, the batch mixture is shaped by extrusion, injection molding, 3D printing, casting, calendaring, spark plasma sintering, hot isotactic pressing, and/or combinations thereof. In one exemplary embodiment, the batch mixture is shaped into a honeycomb configuration as described herein. The batch mixture may be dried following shaping, such as in an ambient environment or at elevated temperatures (such as about 100° C. or less). The batch material may comprise filler material, fibrous material, and inorganic binder. In some embodiments, the batch material may further comprise organic binder to maintain the stability and strength for some particular shape configurations. For example, an organic binder may be utilized when the batch mixture is shaped into a honeycomb configuration.

In some embodiments, the dried, shaped batch mixture may be further subjected to a heat treatment. The heat treatment may generally be at temperatures lower than a temperature sufficient to sinter the materials of the batch mixture after shaping. For some conventional ceramic materials, sintering is observed at temperatures of at least about 1200° C. However, in embodiments described herein, the heat treatment may be at a temperature of less than or equal to about 1000° C., less than or equal to about 900° C., less than or equal to about 800° C., less than or equal to about 700° C., less than or equal to about 600° C., less than or equal to about 500° C., less than or equal to about 400° C., less than or equal to about 300° C., less than or equal to about 200° C., or even less than or equal to about 100° C. In other embodiments, no heat treatment is required. In one exemplary embodiment, the shaped batch mixture may be heated at a temperature of greater than or equal to 400° C. and less than or equal to about 900° C. In another exemplary embodiment, the shaped batch mixture may be heated at a temperature of greater than or equal to 450° C. and less than or equal to about 750° C. The heat treatment may be for a duration sufficient to calcine the materials of the batch mixture. For example, the heat treatment may be for a period of about 0.5 hours, 1 hour, 2 hours, 3 hours, 4 hours, or 5 hours, or a range between any of the disclosed durations. The heat treatment may consolidate and/or stabilized the article for use in operating environments with temperatures up to the heat treatment temperature in desired application. The treatment may also increase the porosity of the shaped article.

In one embodiment, the filler material comprises a ceramic filler. Non-limiting examples of ceramic filler materials include silica, clays, cordierite, mullite powders, ash, glass, titania, alumina, magnesium oxide, aluminum titanate, beta eucryptite, pollucite, zirconias, and/or combinations thereof. Other ceramic materials may also be used as the filler material.

In another embodiment, the filler material may comprise an active filler material. As used herein, an “active material” refers to any material that may be sorbent to, reactive with, or catalytic to a particular chemical species contained in a fluid stream. Non-limiting examples of active filler materials include zeolites, zeolitic imidazolate framework structures, metallic organic frameworks, carbon, perovskites, poylyethelene imine, spinels, titanosilicates, and/or combinations thereof. If the filler material does not comprise an active material, or does not comprise a sufficient amount of an active material to function as a separation device for a gas stream, at least a portion of the surface of the shaped structure may be coated with an active material, such as, but not limited to, those disclosed. If the filler material comprises an active material, an active material coating may not be necessary. When a coating is used, the coating may be applied by any suitable means, such as, but not limited to, dip coating.

In another embodiment, the filler material may comprise a high specific surface area (SSA) material. The high SSA material may increase the specific surface area and volumetric capacity of the shaped article. High specific surface area may promote contact with the a fluid stream directly, or may allow for better coating of an active material onto a shaped article acting as a substrate. In one embodiment, the SSA material may comprise less than or equal to about 50% of the filler material. In an exemplary embodiment, the SSA material may comprise less than or equal to about 30% of the filler material. Non-limiting examples of SSA material include zeolites, meso-porous silicates, zeolitic imidazolate framework structures, metallic organic frameworks, carbon molecular sieves, or combination thereof. In some embodiments, a high SSA material may have a specific surface area of greater than or equal to about 300 m²/g.

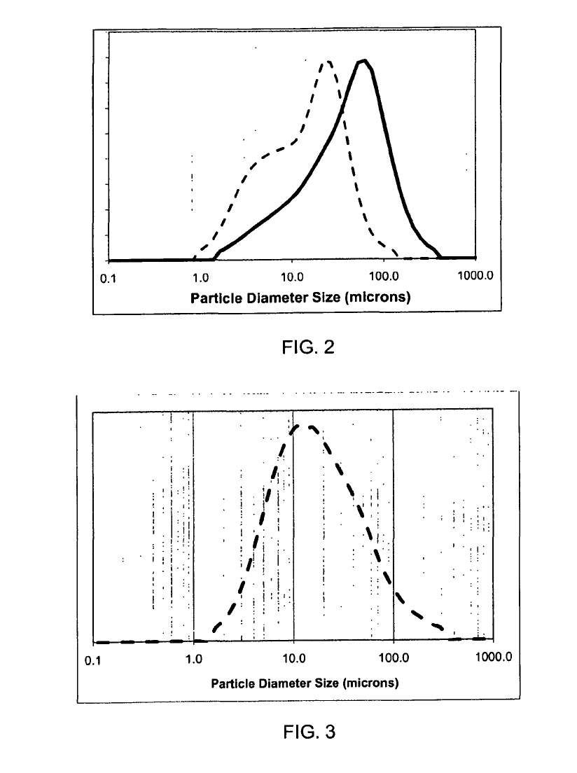

The filler material may comprise a plurality of particles, such as a powder phase, and is mixed with other substances to form the batch mixture. For example, in some embodiments, the filler material may comprise particles that have a mass median diameter (D₅₀) of greater than or equal to about 5 microns and less than or equal to about 80 microns, such as greater than or equal to about 5 microns, greater than or equal to about 10 microns, greater than or equal to 30 microns, greater than or equal to about 40 microns, greater than or equal to about 50 microns, greater than or equal to about 60 microns, or greater than or equal to about 70 microns, or a range between any of the disclosed D₅₀ values. In one exemplary embodiment, the filler material may have a D₅₀ of between about 10 microns and about 40 microns. In another exemplary embodiment, the filler material may have a D₅₀ of between about 20 microns and about 60 microns. In yet another exemplary embodiment, the filler material may have a D₅₀ of between about 60 microns and about 80 microns. It should be understood that the D₅₀ values disclosed herein are based on measurements by a microtrac instrument. For example, FIG. 2 graphically depicts suitable particle size distributions of filler materials. Specifically, FIG. 2 shows particle size distributions for two grades of fused silica (−325 F fused silica denoted by the dotted line and −200 F fused silica denoted by solid line).

In some embodiments, the filler material may have a relatively low coefficient of thermal expansion (CTE). Without being limited by theory, it is believed that a relatively low CTE material may lead to a better thermal shock resistance for the shaped article.

In one exemplary embodiment, fused silica may be used as the filler material. In another exemplary embodiment, ash may be used as the filler material. Both ash and fused silica may have a relatively low CTE, as compared with other suitable filler materials. For example, the CTE of the filler material may be in a range of greater than or equal to about 1×10⁻⁷/° C.) and less than or equal to about 60×10⁻⁷/° C.). In one exemplary embodiment, the CTE of the filler material is greater than or equal to about 10×10⁻⁷/° C.) and less than or equal to about 40×10⁻⁷/° C.).

In one embodiment, the batch mixture may comprise between greater than or equal to about 60 parts by weight and less than or equal to about 98 parts by weight of filler material per 100 parts by weight of the sum of the filler material and fibrous material. In other embodiments, the batch mixture may comprise greater than or equal to about 60 parts by weight, greater than or equal to about 65 parts by weight, greater than or equal to about 70 parts by weight, greater than or equal to about 75 parts by weight, greater than or equal to about 80 parts by weight, greater than or equal to about 85 parts by weight, greater than or equal to about 90 parts by weight, or even about 95 parts by weight, or about 98 parts by weight of filler material per 100 parts by weight of the sum of the filler material and fibrous material, or any range between any of the disclosed amount of filler material per 100 parts by weight of the sum of the filler material and fibrous material. In an exemplary embodiment, the batch mixture may comprise greater than or equal to about 75 parts by weight and less than or equal to about 98 parts by weight of filler material per 100 parts by weight of the sum of the filler material and fibrous material. In another exemplary embodiment, the batch mixture may comprise greater than or equal to about 75 parts by weight and less than or equal to about 98 parts by weight of filler material per 100 parts by weight of the sum of the filler material and fibrous material. In yet another exemplary embodiment, the batch mixture may comprise greater than or equal to about 75 parts by weight and less than or equal to about 90 parts by weight of filler material per 100 parts by weight of the sum of the filler material and fibrous material.

The fibrous material of the batch mixture may comprise any fibrous material suitable for use in a shaped article. The fibrous material may have an aspect ratio as measured by the ratio of the average length to average diameter (length:diameter). In the embodiments described herein, the fibrous material may have an aspect ratio of greater than or equal to about 2:1 and less than or equal to about 40:1, such as about 2:1, 4:1, 6:1, 8:1, 10:1, 15:1, 20:1, 30:1 or 40:1, or any range between these disclosed aspect ratios. In one exemplary embodiment, the fibrous material has an average aspect ratio of greater than or equal to about 2:1 and less than or equal to about 20:1. The fibrous material may have a mass median diameter (D₅₀) based on the diameter of the fibrous material. It should be understood that all D₅₀ values disclosed herein are based on measurements made by a microtrac instrument. The fibrous material may have a D₅₀ of greater than about 4 microns, greater than about 6 microns, greater than about 8 microns, or even greater than about 10 microns. Fibrous materials with a D₅₀ less than about 2 microns may not be desirable, as they may be respirable. Additionally, materials with high bio-persistence may not be desirable.

In an exemplary embodiment, the fibrous material may comprise wollastonite. Wallastonite is a naturally occurring mineral, CaSiO₃. Wollastonite may be in a crystalline form. Non limiting, suitable wollastonites commercially available include Nyglos 4W (commercially available from Nyco and having a D₅₀ of at least about 4 microns with an average aspect ratio of about 4:1) and Ultrafibe II (commercially available from Nyco and having a D₅₀ of at least about 8 microns with an average aspect ratio of about 7:1). Wollastonite may be an exemplary fibrous material as compared to Asbestos, which may have a smaller D₅₀ and be more bio-persistent than Wollastonite. In another exemplary embodiment, the fibrous material may include halloysite. For example, FIG. 3 graphically depicts suitable particle size distributions of fibrous materials. Specifically, FIG. 3. shows particle size distributions for Ultrafibe II Wallostonite.

Without being bound by theory, it is believed that the fibrous material enhances the strength and toughness of the shaped article. However, the fibrous material may have a relatively high CTE, such as greater than about 50×10⁻⁷/° C. Therefore, the amount of fibrous material may be limited to maximize the strength of the shaped article while limiting physical weakness due to high thermal expansion. In one embodiment, the batch mixture may comprise greater than or equal to about 2 parts by weight and less than or equal to about 40 parts by weight of fibrous material per 100 parts by weight of the sum of the filler material and fibrous material. In other embodiments, the batch mixture may comprise about greater than or equal to about 2 parts by weight, greater than or equal to about 5 parts by weight, greater than or equal to about 10 parts by weight, greater than or equal to about 15 parts by weight, greater than or equal to about 20 parts by weight, greater than or equal to about 25 parts by weight, greater than or equal to about 30 parts by weight, greater than or equal to about 35 parts by weight, or about 40 parts by weight of fibrous material per 100 parts by weight of the sum of the filler material and fibrous material, or any range between any of the disclosed amount of fibrous material per 100 parts by weight of the sum of the filler material and fibrous material. In an exemplary embodiment, the batch mixture may comprise greater than or equal to about 10 parts by weight and less than or equal to about 25 parts by weight of fibrous material per 100 parts by weight of the sum of the filler material and fibrous material. In another exemplary embodiment, the batch mixture may comprise greater than or equal to about 2 parts by weight and less than or equal to about 20 parts by weight of fibrous material per 100 parts by weight of the sum of the filler material and fibrous material. In yet another exemplary embodiment, the batch mixture may comprise greater than or equal to about 20 parts by weight and less than or equal to about 40 parts by weight of fibrous material per 100 parts by weight of the sum of the filler material and fibrous material.

The batch mixture may comprise any inorganic binder suitable for use in the shaped article. In one embodiment, the inorganic binder comprises a colloidal material, in a colloidal phase. A non-limiting example of a material in a colloidal phase suitable for use as an inorganic binder is colloidal silica. The colloidal silica may be a monomodal dispersion or a multimodal dispersion with a median diameter of greater than or equal to about 1 nm and less than or equal to about 100 nm, and may have a solids loading of between about 20% and about 50%. Non-limiting examples of colloidal silica commercially available include Ludox PW50EC and Ludox HS 40 (commercially available from W. R. Grace & Co). Non-limiting examples of alternative inorganic binders include colloidal silica, colloidal alumina, colloidal zirconia, silicone emulsions, silicone resins, clays, and/or combinations thereof.

In one embodiment, the batch mixture may comprise greater than or equal to about 10 parts by weight and less than or equal to about 50 parts by weight of inorganic binder (expressed as weight of as-received colloidal suspension) per 100 parts by weight of the sum of the filler material and fibrous material. As used herein, the parts by weight of inorganic binder, if inorganic binder is in a colloidal phase, is expressed as the weight of the as-received colloidal suspension. In other embodiments, the batch mixture may comprise greater than or equal to about 10 parts by weight, greater than or equal to about 15 parts by weight, greater than or equal to about 20 parts by weight, greater than or equal to about 25 parts by weight, greater than or equal to about 30 parts by weight, greater than or equal to about 35 parts by weight, greater than or equal to about 40 parts by weight, greater than or equal to about 45 parts by weight, or about 50 parts by weight of inorganic binder per 100 parts by weight of the sum of the filler material and fibrous material, or any range between any of the disclosed amounts of inorganic binder per 100 parts by weight of the sum of the filler material and fibrous material. In an exemplary embodiment, the batch mixture may comprise between about 10 parts by weight and about 30 parts by weight of inorganic binder per 100 parts by weight of the sum of the filler material and fibrous material. In another exemplary embodiment, the batch mixture may comprise between about 10 parts by weight and about 25 parts by weight of inorganic binder per 100 parts by weight of the sum of the filler material and fibrous material. In yet another exemplary embodiment, the batch mixture may comprise between about 25 parts by weight and about 50 parts by weight of inorganic binder per 100 parts by weight of the sum of the filler material and fibrous material.

In some embodiments, the batch mixture may optionally comprise an organic binder. Non-limiting examples of organic binders include cellulose ethers, water-soluble methylcellulose, hydroxypropyl methylcellulose polymers, gums such as sclerotium gum and xanthan gum, poly vinyl alcohols, starches, and/or combinations thereof. Non-limiting examples of organic binders commercially available include Methocel (commercially available from Dow Chemical) and Actigum (commercially available from Cargill). At least a portion of the organic binder may be burned off during a heating of the shaped article. In some embodiments, the burn off may occur at temperatures of at least about 200° C. The burn off of the organic binder may result in decreased strength in the shaped article when compared with shaped articles that are not heated. For example, in some embodiments, a shaped article heated to about 300° C. may be less strong than a shaped article that has not been heated. However, the shaped article may gain strength when heated to temperatures above about 300° C.

In one embodiment, the batch mixture may comprise greater than or equal to about 1 part by weight and less than or equal to about 12 parts by weight of organic binder per 100 parts by weight of the sum of the filler material and fibrous material. In other embodiments, the batch mixture may comprise greater than or equal to about 1 parts by weight, greater than or equal to about 3 parts by weight, greater than or equal to about 5 parts by weight, greater than or equal to about 7 parts by weight, greater than or equal to about 9 parts by weight, greater than or equal to about 11 parts by weight, or about 12 parts by weight of organic binder per 100 parts by weight of the sum of the filler material and fibrous material, or any range between any of the disclosed amounts of organic binder per 100 parts by weight of the sum of the filler material and fibrous material. In an exemplary embodiment, the batch mixture comprises greater than or equal to about 2 parts by weight and less than or equal to about 8 parts by weight of organic binder per 100 parts by weight of the sum of the filler material and fibrous material. In another exemplary embodiment, the batch mixture comprises greater than or equal to about 1 parts by weight and less than or equal to about 6 parts by weight of organic binder per 100 parts by weight of the sum of the filler material and fibrous material. In yet another exemplary embodiment, the batch mixture comprises greater than or equal to about 6 parts by weight and less than or equal to about 12 parts by weight of organic binder per 100 parts by weight of the sum of the filler material and fibrous material.

The batch material may further comprise a plasticizer, such as water, alcohols, and/or combinations thereof, in an amount sufficient to create a moldable phase, such as a phase capable of being shaped into a honeycomb by extrusion. To form the batch mixture, the filler material, fibrous material, inorganic binder, and optionally an organic binder may be mixed with an appropriate amount of plasticizer so as to facilitate the formation of a plasticized, shapeable material. The amount of plasticizer included in the matrix is a function of the particle sizes of the powders being extruded, and organics being used. Additionally, the amount of plasticizer included is affected by the manufacturing equipment utilized in the shaping of the batch mixture which may vary in parameters such as feed rate requirements, die sizes, etc.

In one embodiment, the material of the shaped article may have a modulus of rupture based on a four point bend test for a 0.25 inch rod made from the material of the shaped article. The modulus of rupture may vary depending on whether a heat treatment is used and upon the temperature of the heat treatment. In one embodiment, the material of the shaped article, without heat treatment (i.e. when the material is in as-formed condition), has a modulus of rupture of greater than or equal to about 700 psi, greater than or equal to about 800 psi, greater than or equal to about 900 psi, or even greater than or equal to about 1000 psi, if extruded into a rod with a 0.25 inch diameter.

In another embodiment, the material of the shaped article, with a heat treatment at or below about 300° C., has a modulus of rupture of greater than or equal to about 300 psi, greater than or equal to about 350 psi, or even greater than or equal to about 400 psi, when extruded into a rod with a 0.25 inch diameter. In some embodiments, the burn off of the organic binder may cause reduced strength compared with a shaped article that is not heated.

In another embodiment, the material of the shaped article, with a heat treatment at or below about 600° C., has a modulus of rupture of greater than or equal to about 700 psi, greater than or equal to about 750 psi, or even greater than or equal to about 800 psi, when extruded into a rod with a 0.25 inch diameter.

In another embodiment, the material of the shaped article, with a heat treatment at or below about 1000° C., has a modulus of rupture of greater than or equal to about 700 psi, greater than or equal to about 800 psi, or even greater than or equal to about 900 psi, when extruded into a rod with a 0.25 inch diameter.

### EXAMPLES

### Example 1

Batch mixtures were prepared with varying amounts and types of filler material, fibrous material, inorganic binder, organic binder, and water. The batch mixtures were extruded into rods with a 0.25 inch diameter. The samples were subjected to heat treatments at various temperatures for 3 hours. The compositions samples are listed in Table 1. The compositions of Table 1 are based on parts by weight compared to the other materials of the compositions.

TABLE 1

| | Filler | | Fibrous | | Organic | | Inorganic | |
|---|---|---|---|---|---|---|---|---|
| Sample # | Material | Parts | Matial | Parts | Binder | Parts | Binder | Parts |
| Sample 1 | −200 F. | 750 | Nyglos 4W | 250 | Culminal 724 | 80 | Ludox | 900 |
| | fused silica | | | | | | PW50EC | |
| Sample 2 | −200 F. | 1000 | N/A | 0 | Actigum CS | 80 | Ludox | 600 |
| | fused silica | | | | | | PW50EC | |
| Sample 3 | −200 F. | 750 | Ultrafibe II | 250 | Actigum CS | 80 | Ludox | 600 |
| | fused silica | | | | | | PW50EC | |
| Sample 4 | −325 F. | 750 | Nyglos 4W | 250 | Culminal 724 | 80 | Ludox | 600 |
| | fused silica | | | | | | PW50EC | |
| Sample 5 | −325 F. | 600 | Nyglos 4W | 400 | Culminal 724 | 80 | Ludox | 600 |
| | fused silica | | | | | | PW50EC | |
| Sample 6 | −325 F. | 600 | Nyglos 4W | 400 | Actigum CS | 80 | Ludox | 600 |
| | fused silica | | | | | | PW50EC | |
| Sample 7 | −200 F. | 750 | Nyglos 4W | 250 | Culminal 724 | 20 | Ludox | 600 |
| | fused silica | | | | | | PW50EC | |
| Sample 8 | −200 F. | 750 | Nyglos 4W | 250 | Culminal 724 | 40 | Ludox | 600 |
| | fused silica | | | | | | PW50EC | |

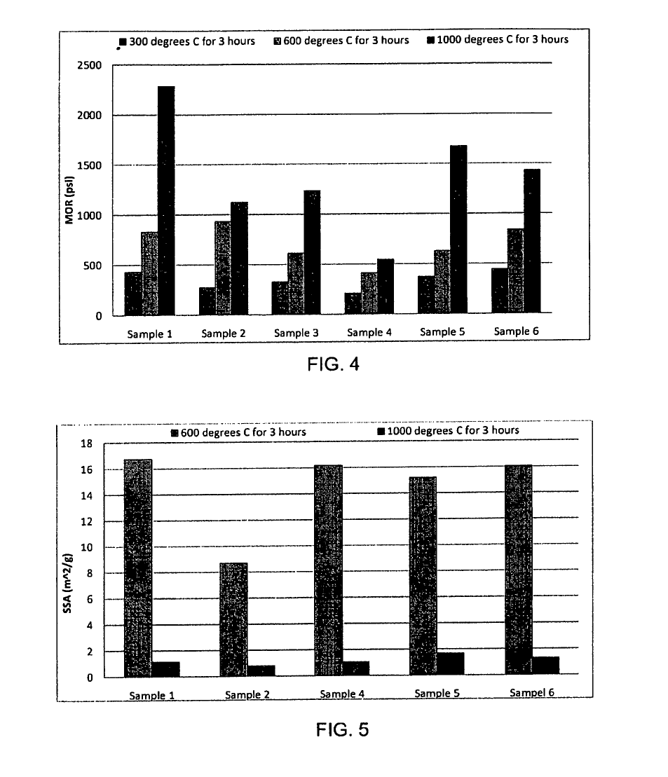

FIG. 4 graphically depicts the modulus of rupture for selected samples (of Table 1). Each selected sample underwent a heat treatment at 300° C. for 3 hours, 600° C. for 3 hours, and 1000° C. for 3 hours. Data is reported for the modulus of rupture (based on a four point bend test) for each sample at each heat treatment temperature for 0.25 inch diameter extruded rods made of the described composition.

FIG. 5 graphically depicts the specific surface area for selected samples (of Table 1). Each selected sample underwent a heat treatment at 600° C. for 3 hours and 1000° C. for 3 hours. Data is reported for the surface area for each sample at each heat treatment temperature for 0.25 inch diameter extruded rods made of the described composition.

### Example 2

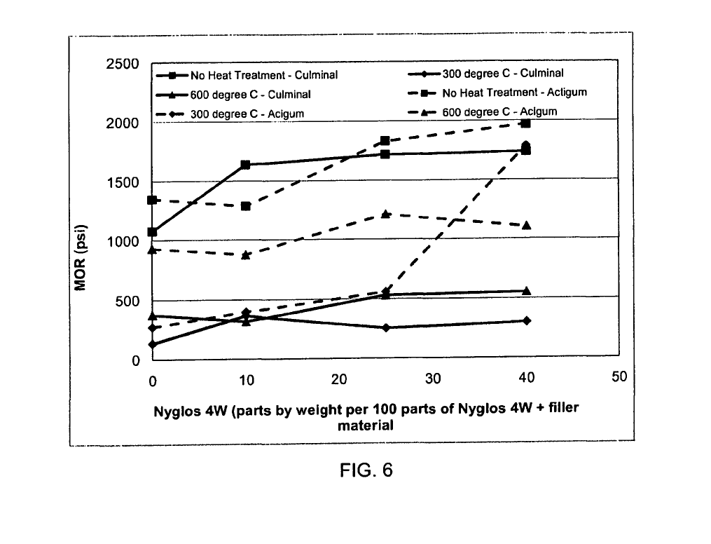

Batch mixtures were prepared as described herein and extruded into rods with a 0.25 inch diameter. The extruded bodies were formed from a varying amount of Nyglos 4W (fibrous material) and varying amounts of −200 F grade fused silica (filler material), as shown on the X-axis as the parts by weight of Nyglos 4W per 100 parts by weight of the sum of Nyglos 4W and −200 F grade fused silica. Additionally, the batch mixture had 8 parts by weight of organic binder (either Actigum CS or Culminal 724) and 60 parts by weight of inorganic binder (Ludox PW50EC) per 100 parts by weight of the sum of Nyglos 4W and −200 F grade fused silica. FIG. 6 graphically depicts the modulus of rupture (based on a four point bend test) for an extruded rod as a function of the compositional ratio of Nyglos 4W (the fibrous phase material) and −200 F grade fused silica (filler material). Each sample underwent a heat treatment at 300° C. for 3 hours and 600° C. for 3 hours. Data is also reported for samples without heat treatment. Additionally, the organic binder was varied, and the data reported for Actigum CS and Culminal 724. Data is also reported for the modulus of rupture for each sample at each heat treatment temperature and for each organic binder.

It should now be understood that shaped articles can be produced which may be used in separation devices, either as a substrate material or as the active material to at least partially separate a component of a fluid stream. The shaped articles can be manufactured at low temperature conditions and with low-cost materials as compared with conventional articles which may require sintering. Indeed, the shaped articles described herein have adequate physical strength and/or toughness without the need for high-temperature sintering. The shaped articles may function as a low cost alternative to sintered materials, especially in separation processes having relatively low-temperature conditions.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Various modifications and variations can be made to the embodiments described herein without departing from the scope of the claimed subject matter. Thus it is intended that the specification cover the modifications and variations of the various embodiments described herein provided such modification and variations come within the scope of the appended claims and their equivalents.

We claim:

1. A method for producing a shaped article for use in a separation device, the method comprising:
forming a batch mixture comprising filler material, fibrous material, and an inorganic binder; and
shaping the batch mixture into a shaped structure, wherein:
the fibrous material has a D₅₀ of greater than or equal to about 4 microns and an average aspect ratio of greater than or equal to about 2:1 and less than or equal to about 20:1;
the batch mixture comprises greater than or equal to about 60 parts by weight and less than or equal to about 98 parts by weight of filler material per 100 parts by weight of the sum of the filler material and fibrous material;
the batch mixture comprises greater than or equal to about 2 parts by weight and less than or equal to about 40 parts by weight of fibrous material per 100 parts by weight of the sum of the filler material and fibrous material; and
the batch mixture comprises greater than or equal to about 10 parts by weight and less than or equal to about 50 parts by weight of inorganic binder per 100 parts by weight of the sum of the filler material and fibrous material.

2. The method of claim 1, wherein the batch mixture is shaped by extrusion, casting, injection molding, calendaring, 3D printing, spark plasma sintering, hot isotactic pressing, or combinations thereof.

3. The method of claim 1, wherein the shaped article is shaped in a honeycomb configuration.

4. The method of claim 1, further comprising heating the shaped batch mixture to a temperature of less than or equal to about 1000° C.

5. The method of claim 1, wherein the material of the batch mixture has a modulus of rupture greater than or equal to about 700 psi when extruded into a rod with a 0.25 inch diameter.

6. The method of claim 1, further comprising coating at least a portion of a surface of the shaped structure with an active material.

7. The method of claim 1, wherein the batch mixture further comprises greater than or equal to about 1 part by weight and less than or equal to about 12 parts by weight of organic binder per 100 parts by weight of the sum of the filler material and fibrous material.

8. The method of claim 1, wherein the filler material comprises a ceramic filler.

9. The method of claim 8, wherein the ceramic filler comprises silica, clays, cordierite, mullite powders, ash, glass, titania, alumina, magnesium oxide, aluminum titanate, beta eucryptite, pollucite, zirconias, or combinations thereof.

10. The method of claim 1, wherein the filler material comprises an active filler.

11. The method of claim 10, wherein the active filler comprises zeolites, zeolitic imidazolate framework structures, metallic organic frameworks, carbon, perovskites, poylyethelene imine, spinets, titanosilicates, or combinations thereof.

12. The method claim 1, wherein the fibrous material comprises wollastonite, halloysite, or combinations thereof.

13. The method claim 1, wherein the inorganic binder comprises colloidal silica, colloidal alumina, colloidal zirconia, silicone emulsions, silicone resins, clays, or combinations thereof.

14. The method claim 1, wherein the inorganic binder comprises a colloidal material.

15. The method claim 1, wherein the batch mixture further comprises an organic binder, the organic binder comprising cellulose ethers, water-soluble methylcellulose, hydroxypropyl methylcellulose polymers, gums such as sclerotium gum and xanthan gum, poly vinyl alcohols, starches, or combinations thereof.

16. A method for producing a honeycomb article for use in a separation device, the method comprising:
forming a batch mixture comprising filler material, fibrous material, inorganic binder, and organic binder; and
shaping the batch mixture into a honeycomb structure, wherein:
the fibrous material has a D₅₀ of greater than or equal to about 4 microns and an average aspect ratio of greater than or equal to about 2:1 and less than or equal to about 20:1;
the batch mixture comprises greater than or equal to about 60 parts by weight and less than or equal to about 98 parts by weight of filler material per 100 parts by weight of the sum of the filler material and fibrous material;
the batch mixture comprises greater than or equal to about 2 parts by weight and less than or equal to about 40 parts by weight of fibrous material per 100 parts by weight of the sum of the filler material and fibrous material;
the batch mixture comprises greater than or equal to about 10 parts by weight and less than or equal to about 50 parts by weight of inorganic binder per 100 parts by weight of the sum of the filler material and fibrous material; and
the batch mixture comprises greater than or equal to about 1 parts by weight and less than or equal to about 12 parts by weight of organic binder per 100 parts by weight of the sum of the filler material and fibrous material.

17. The method of claim 16, further comprising heating the shaped batch mixture to a temperature of less than or equal to about 1000° C.

18. The method of claim 17, wherein the material of the batch mixture has a modulus of rupture greater than or equal to about 700 psi when extruded into a rod with a 0.25 inch diameter.

19. A shaped article for use in a separation device, the shaped article comprising filler material, fibrous material, and inorganic binder, wherein:
the fibrous material has a D₅₀ of greater than or equal to about 4 microns and an average aspect ratio of greater than or equal to about 2:1 and less than or equal to about 20:1;
the shaped article comprises greater than or equal to about 60 parts by weight and less than or equal to about 98 parts by weight of filler material per 100 parts by weight of the sum of the filler material and fibrous material;
the shaped article comprises greater than or equal to about 2 parts by weight and less than or equal to about 40 parts by weight of fibrous material per 100 parts by weight of the sum of the filler material and fibrous material; and
the shaped article comprises greater than or equal to about 10 parts by weight and less than or equal to about 50 parts by weight of inorganic binder per 100 parts by weight of the sum of the filler material and fibrous material.

20. The shaped article of claim 19, wherein the shaped article is a honeycomb.
